(19) United States
(12) Patent Application Publication
(10) Pub. No.: US 2014/0316612 A1
(43) Pub. Date: Oct. 23, 2014

(54) VEHICLE ACCESS SYSTEM

(71) Applicants: Rob BINGLE, Walker, MI (US); Charles Bruce BANTER, Northville, MI (US)

(72) Inventors: Charles Bruce Banter, Northville, MI (US); Rob Bingle, Walker, MI (US)

(21) Appl. No.: 14/370,332

(22) PCT Filed: Jan. 7, 2013
(86) PCT No.: PCT/US2013/020514

§ 371 Date: Jul. 2, 2014

Related U.S. Application Data
(60) Provisional application No. 61/583,343, filed on Jan. 5, 2012.

(51) Int. Cl. E05B 81/80; E05B 81/56

(52) U.S. Cl. CPC E05B 81/80; E05B 81/56
USPC 701/2

(57) ABSTRACT

A system facilitating access to a vehicle when the main battery is incapable of supplying sufficient power for actuating the vehicle's power locks. The system comprises an access device for identifying an authorized user of the vehicle; means positioned in the vehicle for authenticating the remote access device; means positioned in the vehicle for placing the power locks in one of a locked or an unlocked state following authentication of the remote access device by the authenticating means; means positioned in the vehicle for transferring power from an external power supply to the authenticating means and to the means for placing the power locks in a locked or an unlocked state; and an external power supply connectable to the power transferring means to supply power for powering the authenticating means and the means for placing the power locks in a locked or an unlocked state to thereby effect authentication of the remote access device and unlocking/locking the vehicle.

### CROSS-REFERENCE TO RELATED APPLICATIONS

This application is related to, and claims the benefit of priority from, U.S. Provisional Patent Application Ser. No. 61/583,343, filed 5 Jan. 2012, the disclosure of which application is incorporated herein by reference in its entirety.

### FIELD OF THE INVENTION

The present disclosure relates generally to vehicle access systems for vehicles having doors with power locks, and more particularly to systems for actuating the power locks when the vehicle's main battery is sufficiently depleted so as to be incapable of powering actuation of the power locks.

### BACKGROUND

Vehicle doors conventionally include a door latch mechanism housed between inner and outer panels of the door. The latch mechanism cooperates with elements provided on the door frame to latch the door when closed and, in cooperation with a user-actuated release handle, to unlatch the door so that the door can be opened manually.

Current vehicle entry systems utilize key-actuated, mechanical back-up systems to provide secured access to vehicles whose power locks have failed because of failure of the vehicle's main battery. An example of such a conventional power lock system incorporating both an electronic lock and mechanical back-up is shown in FIG. 1. For the primary, electronic lock system, the vehicle's main battery 1 powers (indicated by dotted lines) each of the vehicle's entry control module 2 (such as the body control module—generically referred to herein as a “BCM”—shown in FIG. 1 or other controller(s) responsible for vehicle entry) and antenna 3 (typically positioned in the outside release handle 4) for sending a challenge signal to a “key fob” remote transmitter 5 (typically incorporated into the vehicle's key fob and so referred to as a “key fob remote”). Per convention, after the antenna 3 sends the challenge signal 6 to the “key fob” remote 5, the BCM 2 receives an authentication signal 7 from the “key fob” remote 5. Upon authentication of that authentication signal 7 by the BCM 2, the BCM 2 places a previously locked vehicle in an “unlocked” state in which subsequent operation of the release handle 4 will effect unlatching of the vehicle door. Typically, according to convention, this is via the BCM's momentarily powering an electromechanical latch actuator which couples the door's latch 11 with the release handle 4.

In the event of main battery 1 power failure, a secondary, purely mechanical system comprising an unlocking mechanism 11 (such as, for instance, a key lock cylinder as depicted) is mechanically connected (indicated at solid line 12) to the latch 11 to permit entry into the vehicle. Where these mechanical back-ups are placed within the door, they require space and depth in doors that are become becoming increasingly thinner and packed with more components as vehicles become more complex, thereby introducing increasing design constraints. For instance, conventional mechanical locks require a minimum depth of 45 mm, which is difficult to package in a typical door having a window glass and track mechanism. And where these mechanical back-ups are placed elsewhere on the vehicle, such placement tends to be inconvenient for the vehicle operator, making it more difficult to open the vehicle in the event of main battery failure.

Accordingly, a need exists to have a substitute for mechanical locks to permit access to a vehicle with a dead battery or when the battery is incapable of actuating the power door locks.

### SUMMARY

In addressing the drawbacks of the prior art, there is disclosed an access system for a vehicle of the type having one or more doors with power locks powered by a main battery, the access system facilitating access to the vehicle when the vehicle's battery is incapable of providing power sufficient for actuating the power locks. The access system includes: (a) an access device remote from the vehicle, the access device identifying an authorized user of the vehicle; (b) means positioned in the vehicle for authenticating the remote access device; (c) means positioned in the vehicle for placing the power locks in one of a locked or an unlocked state following authentication of the remote access device by the authenticating means; (d) means positioned in the vehicle for transferring power from an external power supply to the authenticating means and to the means for placing the power locks in a locked or an unlocked state, the power transferring means accessible from an exterior of the vehicle and separate from the vehicle's main battery; and (e) an external power supply connectable to the power transferring means to supply power for powering the authenticating means and the means for placing the power locks in a locked or an unlocked state to thereby effect authentication of the remote access device and unlocking or locking of the vehicle when the main battery is incapable of supplying sufficient power to actuate the power locks.

In one embodiment, the external power supply is directly connectable to the power transferring means.

In another embodiment, the external power supply is indirectly connectable to the power transferring means via induction.

Per one feature, the external power supply and the remote access device are unitary.

Optionally, the system of the present invention may further comprise a rechargeable power supply positioned in the vehicle and rechargeable by the external power supply via the power transferring means, the rechargeable power supply operative to supply power for powering the authenticating means and the means for placing the power locks in a locked or an unlocked state to thereby effect authentication of the remote access device and unlocking or locking of the vehicle when the main battery is incapable of supplying sufficient power to actuate the power locks.

### BRIEF DESCRIPTION OF THE DRAWINGS

FIG. 1 is a schematic depiction of a vehicle access system according to the prior art;

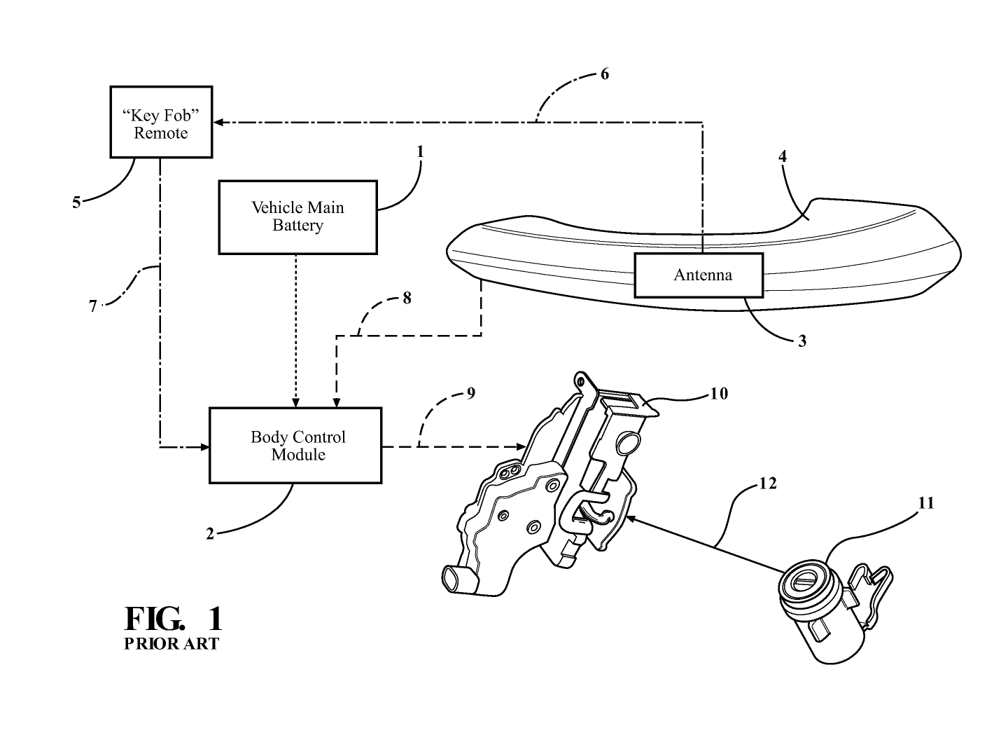

FIG. 2 is a schematic depiction of the components of the vehicle access system of the present invention;

FIGS. 3 and 4 illustrate exemplary locations for providing power transferring means on an exemplary vehicle, as well as means for connecting an external power supply to such power transferring means;

FIGS. 5 and 5A depict one alternative embodiment of the power transferring means, authenticating means and external power supply according to the present invention;

FIGS. 6 and 6A depict a second alternative embodiment of the power transferring means, authenticating means and external power supply according to the present invention;

FIG. 7 depicts various exemplary locations for providing power transferring means on an exemplary vehicle; and

FIG. 8 is a schematic depiction of the components of the vehicle access system according to an alternative embodiment providing each of an external power supply and a rechargeable internal power supply.

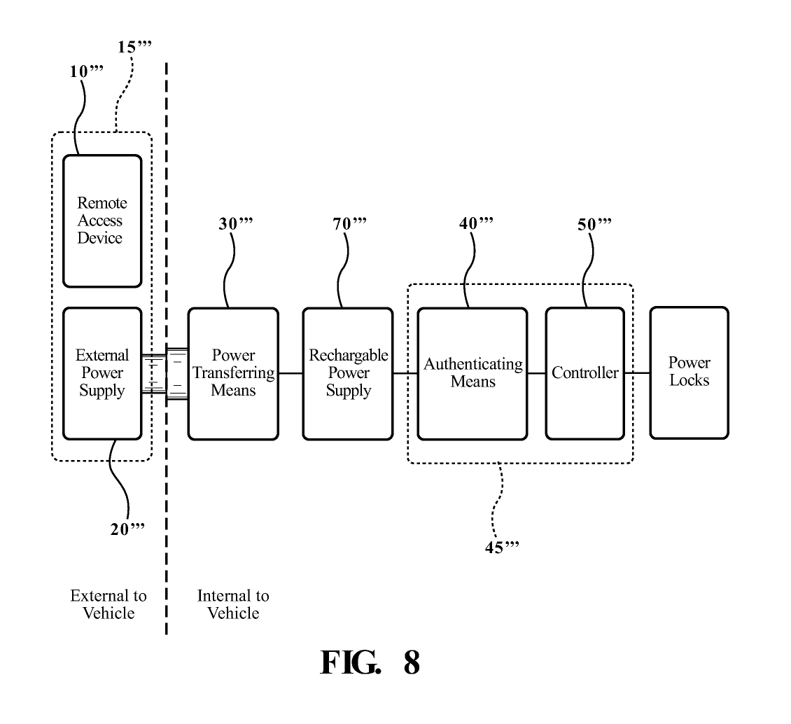

### WRITTEN DESCRIPTION

Referring now to the drawings, the present invention will be seen to generally comprise an access system for a vehicle of the type having one or more doors with power locks powered by a main battery, the access system facilitating access to the vehicle when the vehicle's battery is incapable of powering actuation of the power locks. The access system includes: (a) an access device remote from the vehicle, the access device identifying an authorized user of the vehicle; (b) means positioned in the vehicle for authenticating the remote access device; (c) means positioned in the vehicle for placing the power locks in one of a locked or an unlocked state following authentication of the remote access device by the authenticating means; (d) means positioned in the vehicle for transferring power from an external power supply to the authenticating means and to the means for placing the power locks in a locked or an unlocked state, the power transferring means accessible from an exterior of the vehicle and separate from the vehicle's main battery; and (e) an external power supply connectable to the power transferring means to supply power for powering the authenticating means and the means for placing the power locks in a locked or an unlocked state to thereby effect authentication of the remote access device and unlocking or locking of the vehicle when the main battery is incapable of supplying sufficient power to actuate the power locks.

As used herein, the term “power locks” is intended to refer to a vehicle's powered door latch system, while the means positioned in the vehicle for placing the power locks in one of a locked or an unlocked state comprehends the essential, powered electrical and/or electromechanical components operatively connected to, and necessary to effect actuation of, a vehicle's door latch mechanism by a user's operation of a release handle. According to the prior art, such means may comprise, for example and without limitation, the vehicle's BCM and electromechanical latch actuator.

As will be appreciated by those skilled in the art, the terms “locked” and “unlocked” comprehend the states of power locks in which the components of the power locks are, respectively, coupled or uncoupled so as to permit or prevent opening of a vehicle's door by actuation of a release handle. Accordingly, a vehicle in an unlocked state can be opened, whereas a vehicle in a locked state cannot.

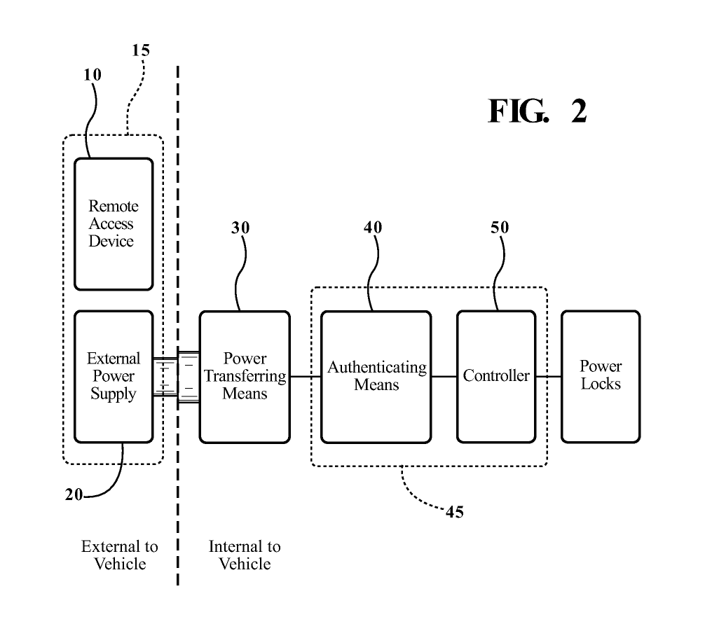

In overview, the system of the present invention permits a vehicle's doors to be unlocked and opened even when the vehicle's main battery is sufficiently drained so as to be incapable of powering actuation of the vehicle's power locks to unlock and open the doors. As shown schematically in FIG. 2, this is effected by an external power supply 20, connectable to the power transferring means 30, for supplying power to the electrical and electromechanical systems necessary to authenticate a user's access to the vehicle and to facilitate subsequent opening the vehicle's door by operation of the release handle. These systems include, for instance, the authenticating means 40 and the means for placing the power locks in a locked or an unlocked state (which, per convention, comprises the entry controller(s) (e.g., the BCM) 50 and any other intermediate powered components necessary to couple the release handle to the latch.

The external power supply 20 and remote access device 10 may be separate components of the system (such as, by way of non-limiting example, a conventional remote access key fob and a conventional battery or other power supply) or may, as denoted by the dashed line 15 in FIG. 2, optionally be unitary, as more fully described below.

The authenticating means 40 and controller 50 may be separate components of the system or may, as denoted by the dashed line 45, optionally be unitary (being, by way of non-limiting example, packaged in or proximate a vehicle door handle), as more fully described below. Further, and though not depicted in FIG. 2, the power transferring means 30 may likewise be unitary with, or positioned in close proximity to, the authenticating means 40 and/or controller 50 (such as, for instance, when two or more of these system components are packaged in or proximate the vehicle door handle).

The various components of this system are described in greater detail below, including in relation to exemplary embodiments thereof.

Remote Access Device and Authenticating Means

With continued reference to FIG. 2, a remote access device 10 capable of use in connection with the present invention may be any conventional remote access device characterized generally by the capacity to identify an authorized operator of the vehicle (at least by virtue of that operator's possession of the remote access device; e.g., a key fob remote). Likewise, authenticating means 40 capable of use in connection with the present invention may be any conventional authenticating means characterized generally by the capacity to authenticate the remote access device. Typically, such remote access devices (which are conventionally incorporated into the vehicle's key fob or into the key itself) and authenticating means work in combination in one of two ways.

The first is by active, user-instigated transmission of a radio signal carrying a unique authentication code to a receiver antenna mounted in the vehicle. The receiver (which may be provided in or proximate a door handle) is operatively connected to a controller (such as the vehicle's body control module, or BCM) which is, in turn, operatively connected to the vehicle's door latches by a latch actuator as described above. Upon verification of the received authentication code, whether by the receiver, BCM or intermediate controller, the BCM powers the latch actuator to couple or uncouple (depending on whether the vehicle was initially in a locked or unlocked state) the release handle and the latch, thereby (in the case where the actuator is coupled to the latch) enabling a user to effect actuation of the vehicle's door latch by operating the release handle.

The second conventional manner of operation of remote access devices is passive. In the case of these devices, one or more combination transmitting/receiving antennas mounted in the vehicle are programmed to periodically transmit a radio signal which effects responsive transmission (transmission that is picked up by the receiving antenna) by the remote access device of a radio signal carrying a unique authentication code. As with active systems, upon verification of the received authentication code, whether by the antenna, BCM or some other, intermediate controller, the BCM powers the latch actuator to enable a user (in the circumstance where the door was previously in a locked state) to effect actuation of the vehicle's door latch by operating the release handle assembly. In some conventional systems, BCM actuation of the power locks is further coupled to user contact with a sensor (e.g., a capacitive sensor) mounted on the vehicle (typically, the door handle). These passive systems—which initiate the authentication steps described above when a user's contact with the vehicle-mounted sensor is detected—act fast enough that the user experiences little or no delay.

It will be appreciated from the foregoing that the term “authenticating means,” as used herein, broadly comprehends any conventional structure capable of identifying the remote access device, including, in the case of active systems, the receiver antenna and associated controller(s) (which may be integral with the receiver antenna or separate, such as in the case of the vehicle's BCM) and, in the case of passive systems, the transmitting/receiving antenna and associated controller(s) (which may likewise be integrated with, or separate from, the antenna).

Without limitation, the foregoing or other conventional remote access devices and authenticating means may be employed in the system of the present invention, it being understood that a remote access device and authenticating means are necessary components of the system fundamentally as a means of authenticating a user's access to a vehicle and, correspondingly, enabling actuation of the vehicle's power locks to lock or unlock the vehicle's doors when the main battery is incapable of providing the power required to actuate the power locks.

According to another embodiment, the authenticating means may be separate from, and independently operable in relation to, other authenticating means provided in the vehicle. In other words, the authenticating means according to this embodiment would effectively operate exclusively in connection with the system of the present invention (and, thus, separate authenticating means would effect actuation of the power locks when the vehicle's main battery is capable of providing power to actuate the power locks). To this end, such authenticating means would be provided on a separate circuit operatively connected to the power latches and be powered by the external power supply. Such authenticating means may operate according to any conventional means using any conventional construction (such as, for instance, immobilizer RL circuits, low frequency radio transmission, radio frequency identification (“RFID”)), including as heretofore described. Further, and as discussed elsewhere herein, such separate authenticating means may be unitary with the controller 50.

External Power Supply and Power Transferring Means

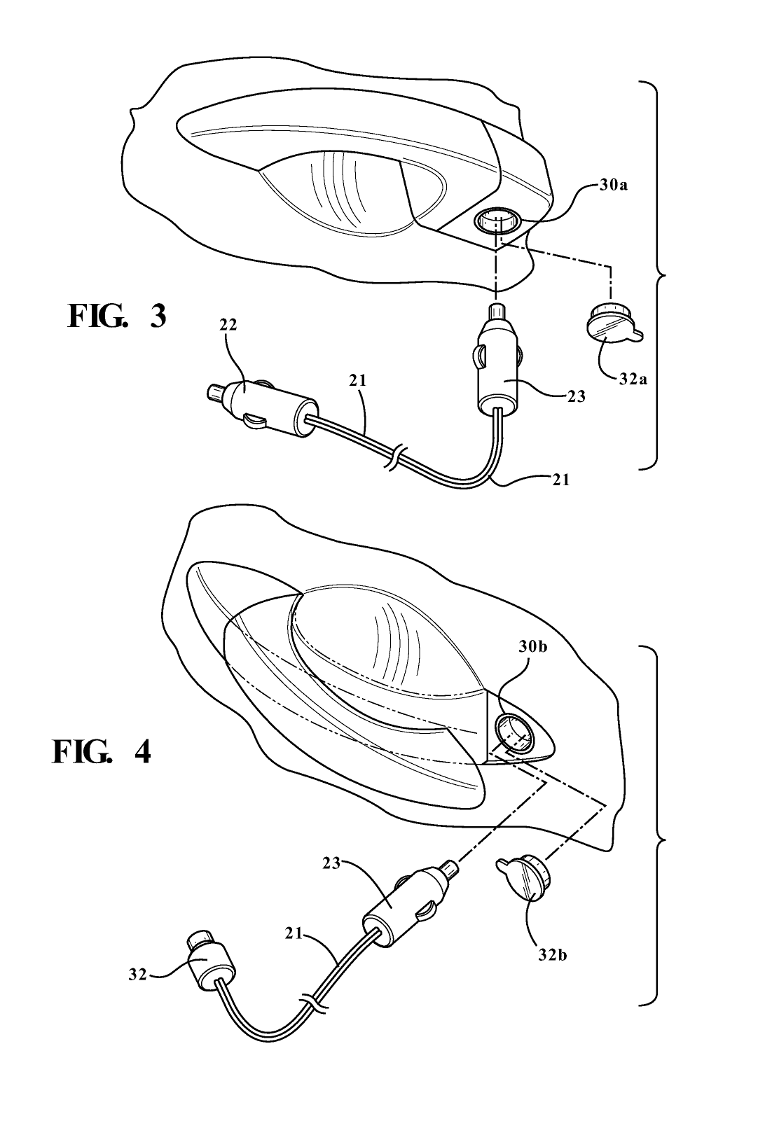

With continued reference to FIG. 2, external power supply 20 generally comprises a source of power, connectable to the power transferring means 30, that is sufficient to power the authenticating means 40 and the controller 50 to effect authentication of the remote access device and unlocking or locking of the vehicle when the main battery is incapable of supplying power sufficient to power actuation of the power locks. The external power supply 20 may comprise a low power (for instance, 12V, 9V or 5V DC) source, for instance. Suitable sources may include, by way of non-limiting example, another vehicle's 12V power source (such as a cigarette lighter), a cell phone, a laptop computer, a conventional battery, etc. Where the external power supply 20 constitutes an external device of conventional manufacture, it will be appreciated that the external power supply may need to be connectable to the power transferring means 30 via an interconnection suitable to the external device. Thus, for example, there are depicted in FIGS. 3 and 4 embodiments of the present invention wherein the external power supply comprises a vehicle's 12V power supply, such as a cigarette lighter (not shown), and according to which that power supply is connectable to the power transferring means (indicated generally at 30a and 30b, respectively) via a cable 21 having a plug 22 at one end of conventional construction which is compatible with the 12V power supply port in a vehicle. The other end of that cable 21 may, as shown, have a similar plug 23 for receipt in the power transferring means 30a, 30b. Alternatively, it will be appreciated that the interconnection between the power transferring means 30 and the cable or other device for interconnecting the power transferring means to the external power supply 20 may be any known plug/receptacle combination. Other suitable interconnecting devices may include USB cables, mini-USB cables, etc.

Where, alternatively, the external power supply simply comprises a conventional battery, interconnection with the power transferring means may be effected merely by the provision of suitable contacts at the power transferring means for direct electrical interconnection with the contacts of the battery.

As described more particularly below, it is also contemplated that the external power supply 30 may be a device specifically designed for use in connection with the system of the present invention, and so have a plug specifically designed for a correspondingly uniquely-shaped receptacle at the power transferring means 30.

As will be appreciated from the foregoing, the power transferring means 30 comprehend, most essentially, one or more electrical connections, accessible to a user from external locations on the vehicle, via which power from the external power supply can be coupled to supply power to the authenticating means 40 and controller 50. As heretofore described, the power transferring means 30 comprehend physical receptacles, such as USB ports, “cigarette-lighter plug”-style receptacles, specially-configured receptacles, etc. However, it is also contemplated that the power transferring means 30 may comprehend means to effect the wireless transfer of power from the external power supply to the authenticating means 40 and controller 50. In these regards, those skilled in the art will understand that there exist several different conventional means for wirelessly transferring power from a power source, including several different means of effecting inductive power transfer such as, for instance, electrodynamic induction. In electrodynamic induction, electric current flowing through a primary coil creates a magnetic field that wirelessly acts on a remote secondary coil to produce a current through a process known as mutual induction. According to the foregoing, whether by electrodynamic induction or other inductive power transfer, it is contemplated that the external power supply 20 will constitute the component for generating the magnetic field, while the power transferring means 30 will constitute the component in which a current is induced, that current supplying power to the authenticating means 40 and controller 50.

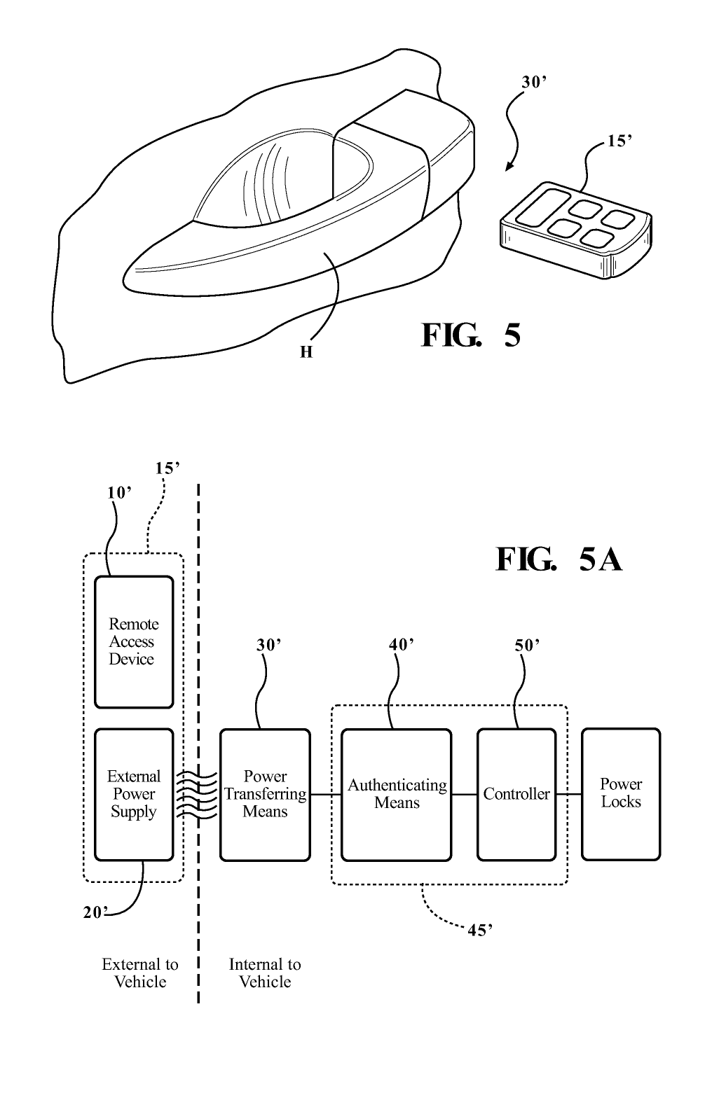

Referring to FIG. 5, there is shown one embodiment of the invention wherein the remote access device 10′ comprises the external power supply in the form of a battery-powered primary coil for inducing through a magnetic field the generation of an electrical current in the secondary coil of the power transferring means 30′ (disposed, in the illustrated embodiment, in the fixed base portion of the door handle assembly H of a vehicle). As will be appreciated, power transfer from the external power supply to the power transfer means is effected by simply holding the remote access device 10′ in close proximity to the power transfer means 30′ in order to generate the required current to power the authenticating means and controller.

A schematic depiction of the embodiment of FIG. 5 is depicted in FIG. 5A.

Referring next to FIG. 5, there is shown another embodiment of the invention wherein, as with the embodiment of FIG. 5, the remote access device 10″ and external power supply are unitary. In this embodiment, the external power supply may comprise a suitable battery electrically coupled to contacts provided on a plug portion 11″ of the remote access device 10″. That plug portion 11″ is shaped to be inserted into a correspondingly shaped receptacle 31″ of the power transfer means provided on the vehicle (in this instance, a fixed base portion of the vehicle door handle assembly H), that receptacle including contacts to effect the transfer of current from the power supply. As shown, the receptacle 31″ may include a cover 32″ that can be selectively closed/opened to conceal/reveal the receptacle.

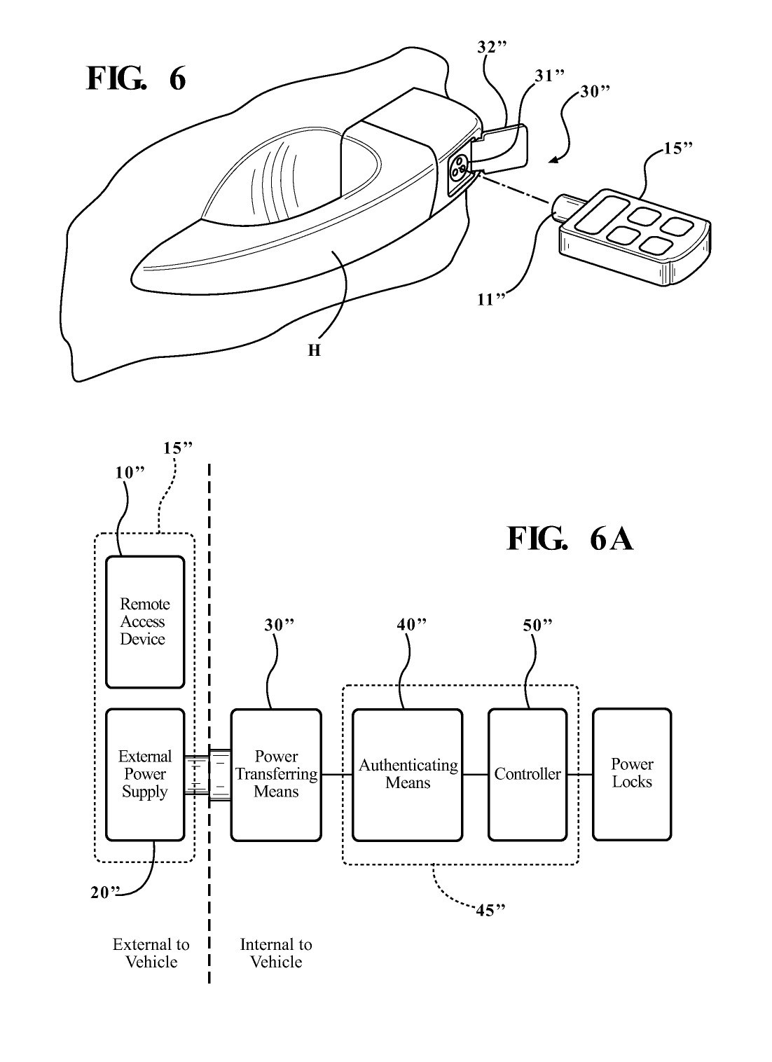

A schematic depiction of the embodiment of FIG. 6 is depicted in FIG. 5A.

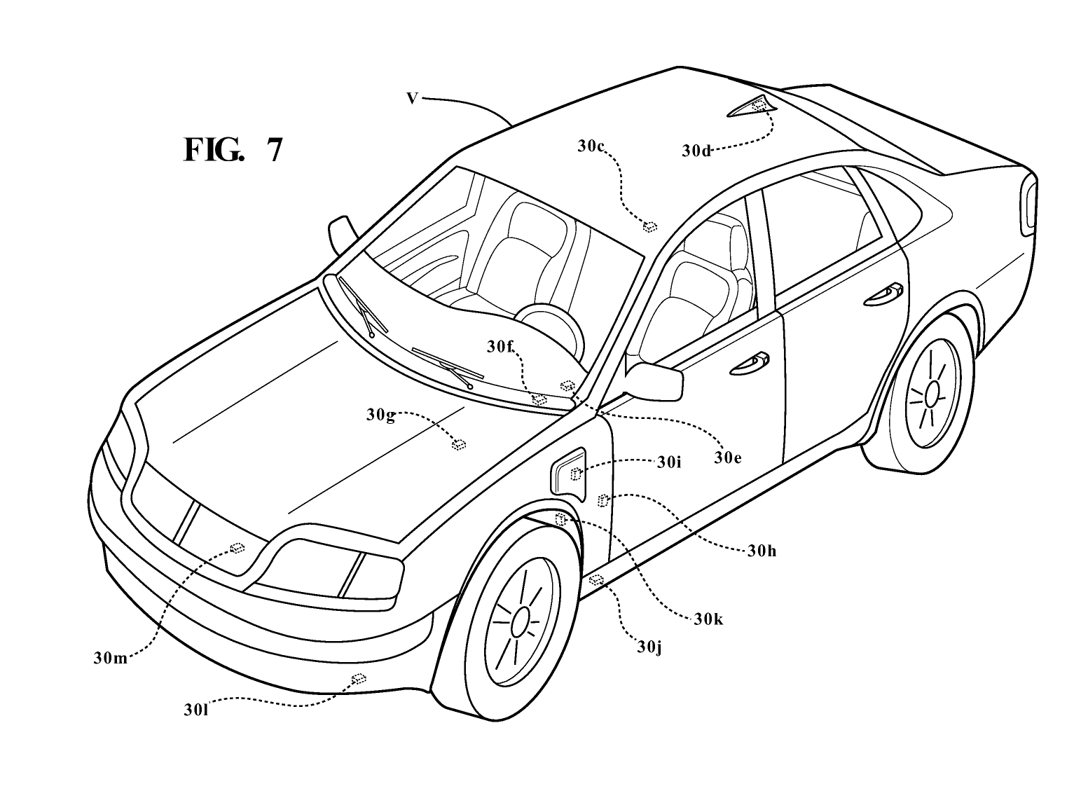

Referring now to FIG. 7, there is illustrated a representative vehicle V having shown thereon possible locations for the disposition of externally accessible power transferring means 30. As depicted, such possible locations include the vehicle roof 30c, the vehicle antenna cover 30d, the vehicle body shell 30e, the leaf screen 30f, the hood 30g, the fender 30h, fender vents 30i, body trim elements 30j, wheel wells 30k, bumper 30l, and/or the grill 30m. It will be appreciated that the depicted locations are not intended to be exhaustive of possible locations for the power transferring means and, moreover, that any given vehicle may include one or more power transferring means at the depicted, as well as other, locations.

Other exemplary locations for the power transferring means will be seen to include side view mirror housings (30a) or in the pocket behind a vehicle's door handles (30b). As shown in FIGS. 2 and 3, each receptacle for the power transferring means may be provided with a selectively removable plug 32a, 32b to keep the receptacle free of debris, ice or other obstruction, as well as to provide a more aesthetically pleasing appearance, when not in use. Similar or other plugs, covers or the like may also be provided for receptacles disposed in other locations about the vehicle, including any of the locations described above in relation to FIG. 6.

Controller

The controller portion of the present invention may take the form of the vehicle's BCM or other on-board controller or controllers already provided on the vehicle and operative to effect actuation of the vehicle's power locks in the manner heretofore described. Conventionally, this takes the form of the BCM or other entry control module operatively connected (such as via a latch actuator) to the vehicle's latches to place the latches in an unlocked or locked state (depending on their initial state). According to this embodiment of the invention, it will be appreciated that the vehicle need be modified only to the extent necessary to provide power transferring means capable of transferring power from an external power supply to the authenticating means and the controller or controllers. In the alternative, the system of the present invention can take the form of a separate controller operative to unlock or lock the power locks following authentication of the remote access device by the authenticating means. Where the vehicle is provided with a BCM or other controller to control the power locks when the vehicle's main battery is suitably charged, the separate controller of this embodiment will be isolated from the BCM or other controller, and will be directly operatively connected to the latches to effect independent actuation thereof. In this case, the controller would be provided on a separate circuit operatively connected to the latches and powered by the external power supply.

As discussed elsewhere, such a separate controller may be unitary with the authentication means, with the authenticating and locking/unlocking functions programmed into the same PCB or separate PCBs, for instance.

It will be appreciated that, where the BCM constitutes the controller for effecting operation of a latch actuator and also authenticates a user's access to the vehicle, the controller will also constitute part of the authenticating means.

Rechargeable Power Supply

Optionally, the system of the present invention may further comprise a rechargeable power supply 70 positionable in the vehicle and rechargeable by the external power supply via the power transferring means. See FIG. 7. The rechargeable power supply 70 is operative to supply power for powering the authenticating means, the controller and the power latches to effect authentication of the remote access device and unlocking or locking of the vehicle when the main battery is incapable of actuating the power latches. Accordingly, the power supply 70 provides a back-up source of power to power the authenticating means, the controller and the power latches, which source of power is immediately available when the vehicle's main battery is incapable of actuating the power locks, and which source of power may be recharged after use by means of the external power supply 20′″.

Where the controller is other than the vehicle's integrated BCM and a rechargeable power supply is provided, it is contemplated that the controller will be programmed to identify when the vehicle's main battery is incapable of supplying power sufficient to actuate the power locks, in order that the controller not operate concurrently with operation of the vehicle's primary power lock actuating system. To this end, for instance and without limitation, the controller may be operatively connected to the BCM and programmed to either query or receive information from the BCM regarding the condition of the vehicle's main battery. Consistent therewith, the controller would be programmed to effect locking/unlocking of the vehicle's power locks only in the event that the vehicle's main battery were established to be incapable of actuating the power locks. Establishing that condition could, in one exemplary embodiment, be effected by a signal from the controller in the event that the main battery reaches a charge level predetermined to be incapable of providing sufficient power to actuate the vehicle's power locks. Of course, other means could be employed to make the same determination.

Where the controller is the vehicle BCM and a rechargeable power supply is provided, it is contemplated that the BCM will be programmed to recognize when the main battery is incapable of providing sufficient power to actuate the vehicle's power locks and, moreover, to alternate to operation of the authenticating means and power locks via power from the rechargeable power supply.

By the foregoing, it will be appreciated that the present invention comprehends a system whereby a vehicle's power locks can be actuated even when the vehicle's main battery is incapable of supplying power sufficient to actuate the power locks, and that this system can either incorporate a vehicle's existing authenticating means and/or power lock controller(s) or, alternatively, comprise separate authenticating means and/or a power lock controller.

In operation of the present invention where no rechargeable power supply is provided in the vehicle, a user in possession of the remote access device will, having established that the vehicle will not lock or unlock as normal, connect the external power supply to the power transferring means provided at one or more locations on the vehicle. On receipt of power from the external power supply via the power transferring means, the authenticating means will operate to establish that the remote access device is authorized for that vehicle. Upon such authentication, the controller(s) will effect actuation of the power locks in the manner heretofore described to either lock or unlock the vehicle (depending upon the initial state of the power locks).

In operation of the present invention where a rechargeable power supply is provided in the vehicle, the controller will, upon establishing the inability of the vehicle's main battery to effect actuation of the vehicle's power locks, provide power to the authenticating means, which will operate to establish that a user's remote access device is authorized for that vehicle. Upon such authentication, the controller(s), also powered by the rechargeable power supply, will effect actuation of the power locks to either lock or unlock the vehicle (depending upon the initial state of the power locks). Thereafter, the user may recharge the rechargeable power supply with the external power supply via the power transferring means.

Many modifications and variations of the present disclosure, all of which will be apparent to those skilled in the art having the benefit of this disclosure, are possible in light of the above teachings. Therefore, within the scope of the appended claims, the present disclosure may be practiced other than as specifically described.

The invention in which an exclusive property or privilege is claimed is defined as follows:

1. An access system for a vehicle of the type having one or more doors with power locks powered by a main battery, the access system facilitating access to the vehicle when the vehicle's battery is incapable of supplying sufficient power for actuating the power locks, the access system comprising:
(a) an access device remote from the vehicle, the access device identifying an authorized user of the vehicle;
(b) means positioned in the vehicle for authenticating the remote access device;
(c) means positioned in the vehicle for placing the power locks in one of a locked or an unlocked state following authentication of the remote access device by the authenticating means;
(d) means positioned in the vehicle for transferring power from an external power supply to the authenticating means and to the means for placing the power locks in a locked or an unlocked state, the power transferring means accessible from an exterior of the vehicle and separate from the vehicle's main battery; and
(e) an external power supply connectable to the power transferring means to supply power for powering the authenticating means and the means for placing the power locks in a locked or an unlocked state to thereby effect authentication of the remote access device and unlocking or locking of the vehicle when the main battery is incapable of supplying sufficient power to actuate the power locks.

2. The access system of claim 1, wherein the external power supply is directly connectable to the power transferring means.

3. The access system of claim 1, wherein the external power supply is indirectly connectable to the power transferring means via induction.

4. The access system of claim 1, wherein the external power supply and the remote access device are unitary.

5. The access system of claim 1, further comprising a rechargeable power supply positioned in the vehicle and rechargeable by the external power supply via the power transferring means, the rechargeable power supply operative to supply power for powering the authenticating means and the means for placing the power locks in a locked or an unlocked state to thereby effect authentication of the remote access device and unlocking or locking of the vehicle when the main battery is incapable of supplying sufficient power to actuate the power locks.
